(19) United States
(12) Patent Application Publication
(10) Pub. No.: US 2015/0178289 A1
(43) Pub. Date: Jun. 25, 2015

(54) Identifying Semantically-Meaningful Text Selections

(71) Applicant: Google Inc., Mountain View, CA (US)

(72) Inventor: David Reis de Sousa, Belo Horizonte (BR)

(73) Assignee: Google Inc., Mountain View, CA (US)

(21) Appl. No.: 14/137,397

(22) Filed: Dec. 20, 2013

(51) Int. Cl. G06F 17/30

(52) U.S. Cl. CPC G06F 17/3061

(57) ABSTRACT

A text selection module enables a user to quickly designate a semantically-meaningful phrase within a text region of a user interface. The text selection module may further automatically or semi-automatically take an action on the designated phrase, such as visually selecting the phrase, obtaining a definition of the phrase, or the like.

### BACKGROUND

1. Field of Art

The present invention generally relates to the field of user interfaces, and more specifically, to aiding a user in making semantically-meaningful textual selections.

2. Description of the Related Art

Many software applications, such as web browsers, book readers, word processing programs, and the like display significant amounts of textual content to users. Additionally, those applications—or other third-party applications that interact with the text in the software applications—may permit users to take actions with respect to user-specified text. For example, a book reader application on a smartphone might allow a user to press on or otherwise designate a word in the text representing a concept for which a definition is desired, and accordingly find and display a definition for that concept.

However, in many instances the concepts in which the user is interested are not represented merely by single words, but rather by multi-word phrases. Thus, in order to accurately designate the concept of interest from the text, the user is obliged (for example) to expand a selection of a single word to include all the words in the multi-word phrase. This requires extra effort on the part of the user, particularly for user input devices such as touchscreens of mobile devices where the text selection capabilities are relatively less precise and more error-prone than with other types of input devices.

### BRIEF SUMMARY

In one embodiment, a computer-implemented method comprises receiving a user interaction with a first word in an ordered set of words displayed in a user interface, forming a set of candidate n-grams, each candidate n-gram being a sequence of up to n adjacent words within the ordered set of words that includes the first word, identifying known n-grams within the set of candidate n-grams, and taking an action on one of the identified known n-grams.

In one embodiment, a non-transitory computer-readable storage medium comprising instructions executable by a processor, the instructions comprising instructions for receiving a user interaction with a first word in an ordered set of words displayed in a user interface, instructions for forming a set of candidate n-grams, each candidate n-gram being a sequence of up to n adjacent words within the ordered set of words that includes the first word, instructions for identifying known n-grams within the set of candidate n-grams, and instructions for taking an action on one of the identified known n-grams.

In one embodiment, a computer system comprises a computer processor and a non-transitory computer-readable storage medium. The non-transitory computer-readable storage medium comprises instructions for receiving a user interaction with a first word in an ordered set of words displayed in a user interface, instructions for forming a set of candidate n-grams, each candidate n-gram being a sequence of up to n adjacent words within the ordered set of words that includes the first word, instructions for identifying known n-grams within the set of candidate n-grams, and instructions for taking an action on one of the identified known n-grams.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIGS. 1A-1E illustrate explicit user selections of text within a user interface and automatic modifications to the user selections, as performed according to one embodiment.

FIG. 2 is a high-level block diagram illustrating a detailed view of a client device 200 on which text selection expansion is performed, according to one embodiment.

FIG. 3 is a flowchart illustrating actions of the text expansion module 206, according to one embodiment.

FIG. 4 is a high-level block diagram illustrating physical components of the client device 200 of FIG. 2, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

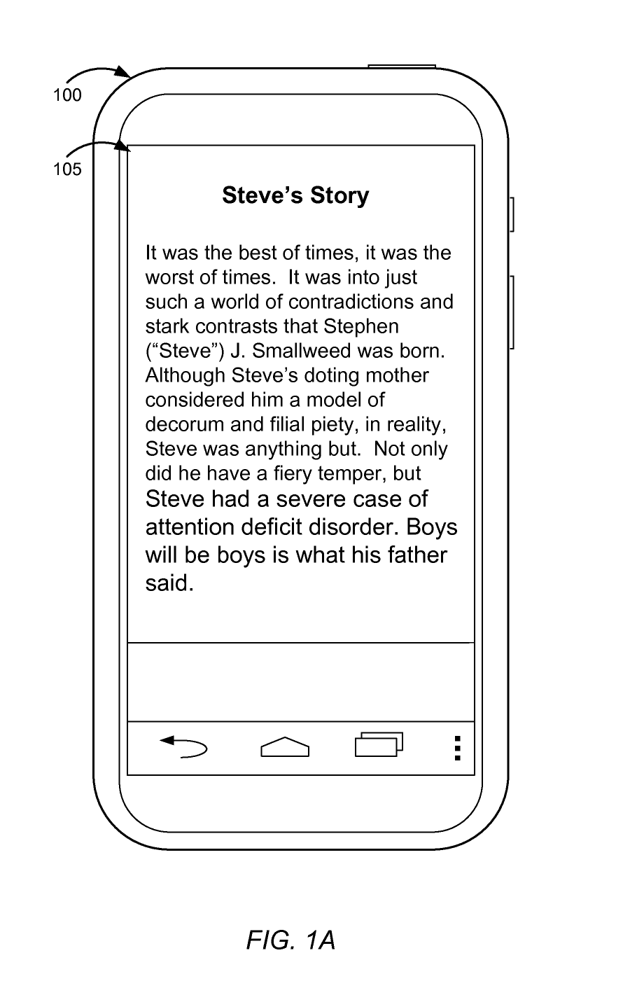

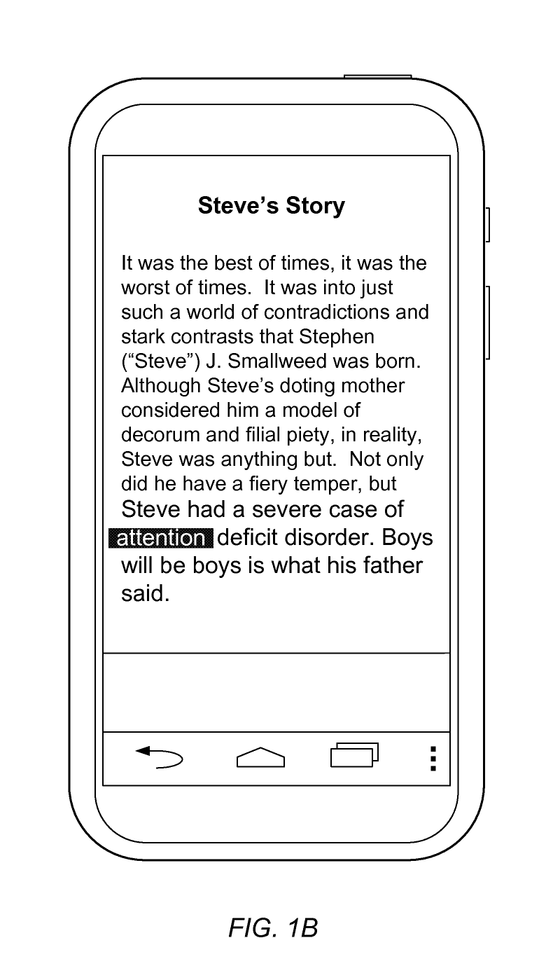

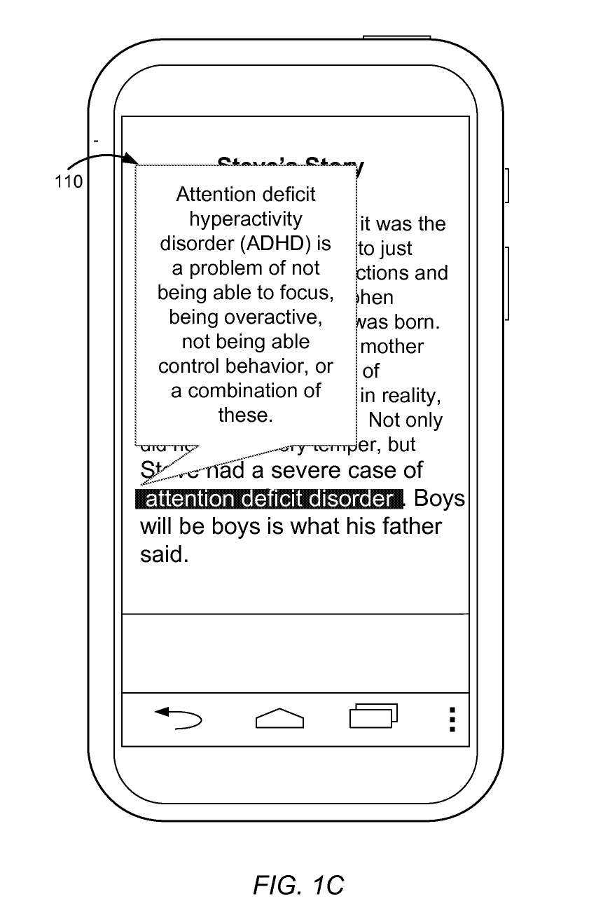

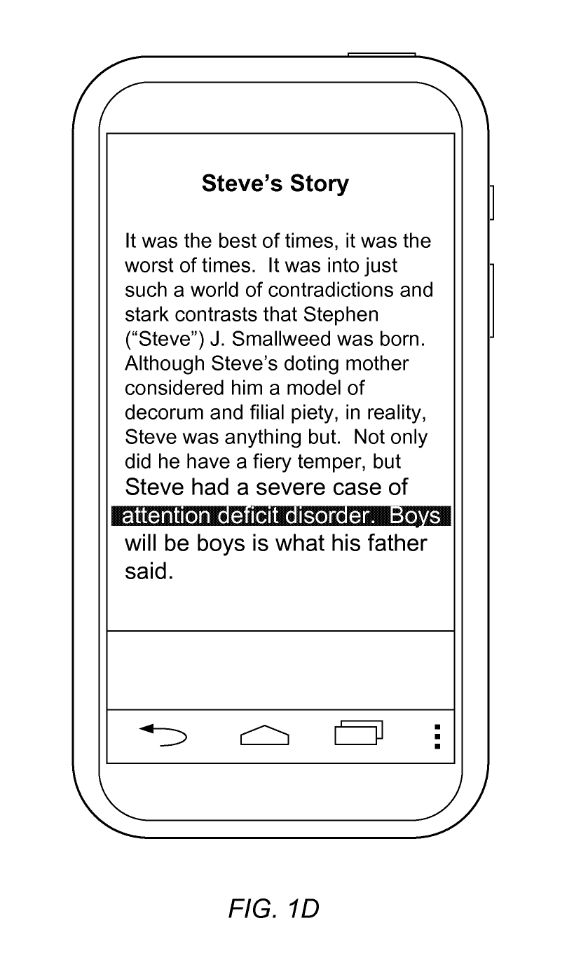

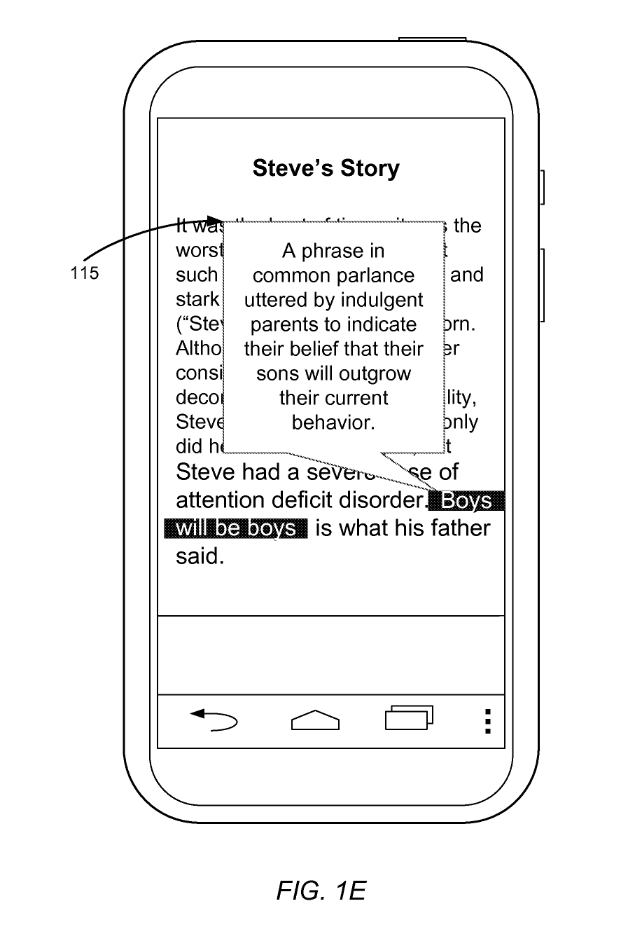

FIGS. 1A-1E illustrate explicit user selections of text within a user interface and automatic modifications to the user selections, as performed according to one embodiment.

FIG. 1A illustrates text displayed within a text region 105 of the user interface displayed on a client device 100. The text includes the character string, “Steve had a severe case of attention deficit disorder. Boys will be boys is what his father said.” The character string may be considered to represent an ordered set of word tokens such as “Steve”, “had”, “a”, “severe”, “case”, “of”, “attention”, “deficit”, “disorder”, “Boys”, “will”, “be”, “boys”, “is”, “what”, “his”, “father”, “said”, in which the word tokens are sequences of alphabetic characters separated by whitespace or punctuation, although it is appreciated that many other alternative word tokenization schemes are also possible.

FIG. 1B illustrates the same text region 105 after explicit user selection of the word “attention” towards the bottom of the text region. (A “selection” of text is used herein to denote the placing of a visual emphasis on that text, such as background highlighting.) The selection may have been accomplished by (for example) the user pressing and holding over the portion of the screen corresponding to the selected word or other making another gesture.

FIG. 1C illustrates the same text region 105 after automatic expansion of the user selection to include a larger semantically-meaningful phrase. (A phrase is hereinafter also referred to as an “n-gram,” a sequence of up to n adjacent word tokens.) Specifically, the n-gram “attention deficit disorder” has been selected, since this n-gram represents a concept that contains the user-selected word “attention” but that has its own specific meaning. Automatic selection of the n-gram “attention deficit disorder” frees the user from the necessity of expanding the selection of “attention” outward to additionally encompass “deficit disorder” in order to select the intended n-gram.

Further, a definition for the n-gram “attention deficit disorder” has been displayed in a region 110 of FIG. 1C, e.g., in response to the user manually selecting a “Show definition of selection” element of the user interface after the automatic selection of the n-gram “attention deficit disorder.”

FIG. 1D illustrates the same text region 105 after the user has manually expanded the selection one word to the right, to include the word “Boys.” (In the case of smartphone user interfaces, such as that depicted in FIG. 1D, the expansion of the selection might entail dragging and dropping a right boundary marker of the selection one word to the right, for example.)

FIG. 1E illustrates the same text region 105 after automatic further expansion of a portion of the text selection of FIG. 1D to include another semantically-meaningful n-gram. Specifically, the word “Boys” was included in the user expansion of FIG. 1D, and FIG. 1E illustrates the automated selection of the larger n-gram “Boys will be boys,” a well-known aphorism, and the de-selection of a portion of the original selection (“attention deficit disorder”) that is not semantically-related to the n-gram “Boys will be boys.” Alternatively, the original selection “attention deficit disorder. Boys” could remain selected in its entirety, and merely extended by including “will be boys” to form the selection “attention deficit disorder. Boys will be boys,” a concatenation of two distinct semantically-meaningful n-grams. An explanation of the n-gram “Boys will be boys” is additionally displayed in a region 115 of the user interface.

It is appreciated that although the client device 100 illustrated in FIGS. 1A-1E is depicted as a smartphone device, the text selection expansions described herein are not limited to smartphone user interfaces. Rather, the described text selection expansions could equally be performed within a variety of application on a variety of platforms, such as a web browser on a desktop computer equipped with a keyboard and mouse, or a book reader application on a laptop computer, in addition to the application on the smartphone depicted in FIGS. 1A-1E.

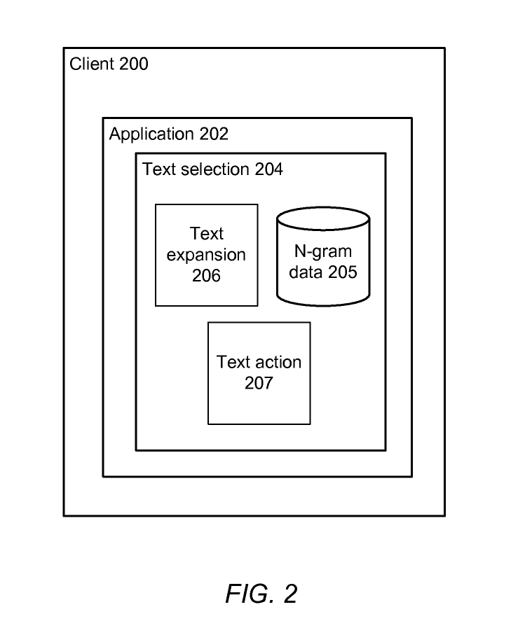

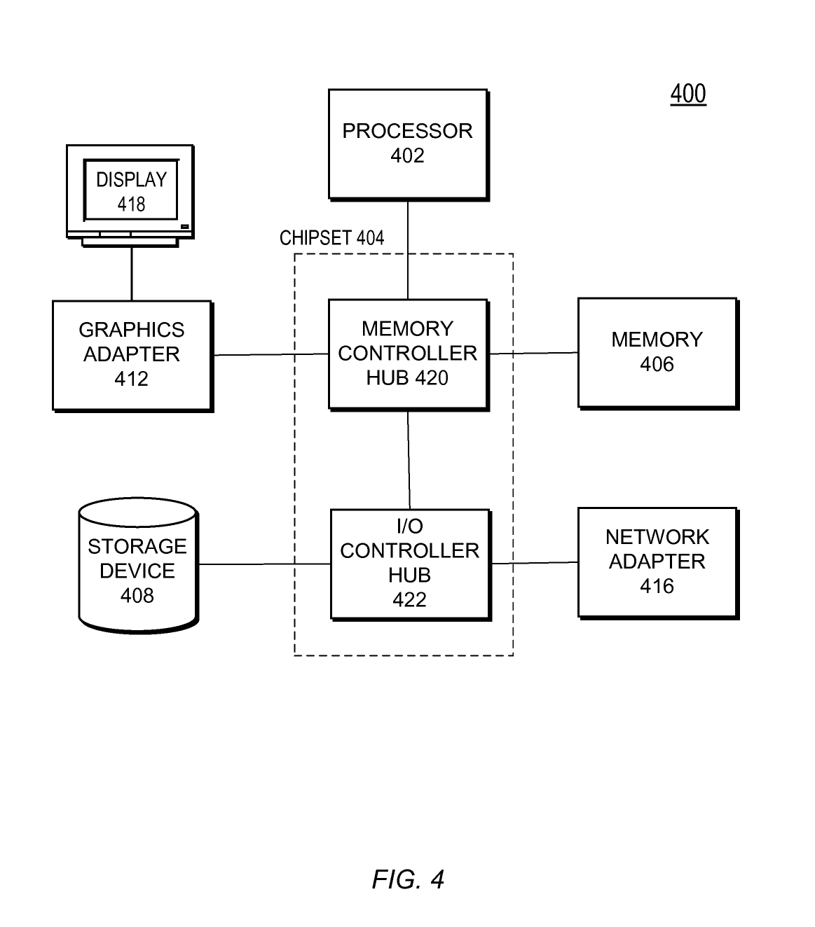

FIG. 2 is a high-level block diagram illustrating a detailed view of a client device 200 on which text selection expansion is performed, according to one embodiment. The client device 200 represents any computing system capable of displaying a user interface using which a user can view and interact with text. For example, the client device 200 could be a desktop, laptop, or tablet computer, a personal digital assistant, a smartphone, or the like. The hardware components for one possible client device 200 are described below with respect to FIG. 4.

The client device 200 has a software application 202 that displays text and allows users to interact with that text. Examples of the software application 202 include, but are not limited to, web browsers, book readers, word processing programs, and the like.

The application 202 in turn includes a text selection module 204 that is responsible for text selection and for automatically identifying semantically-meaningful expansions of selected text. The text selection module 204 includes a text expansion module 206 that determines whether, and how, to expand user-designated text within a text region of the user interface into a larger semantically-meaningful n-gram, an n-gram data store 205 defining known n-grams, and a text action module 207 taking actions with respect to the expanded n-gram, each of which are now described in additional detail.

The n-gram data store 205 comprises a set of known n-grams, each n-gram being a character string representing an ordered set of from 1 to n adjacent word tokens, for some positive integer n. Referring to the above examples, n-grams where n=4 include “attention”, “of attention”, “attention deficit”, “attention deficit disorder”, and “attention deficit disorder. Boys”, but not “attention deficit disorder. Boys will” (which has more than n=4 word tokens, namely the 5 word tokens “attention”, “deficit”, “disorder”, “Boys”, and “will”). The word tokens may be identified within the character string according to different word tokenization techniques. For example, one such technique might parse words as contiguous sequences of alphabetic characters separated by whitespace or punctuation, although it is appreciated that many different such techniques could alternatively be employed. The n-gram data store 205 is made up of “known” n-grams—that is, n-grams whose constituent words have been previously observed to occur together in the given sequence with some minimum degree of frequency, and are thus considered semantically-meaningful. For example, the n-gram “attention deficit disorder” would likely be a known n-gram, because the words “attention”, “deficit”, and “disorder” are often used together in that sequence, and therefore are presumed to have special meaning when taken together that is distinct from the meanings of the individual words taken in isolation. In contrast, the n-gram “disorder. Boys” would likely not be a known n-gram, since the words “disorder” and “Boys” are not used together in sequence with more than usual frequency, and therefore presumably have no special meaning when taken together.

In one embodiment, the n-gram data store 205 is created automatically or semi-automatically by analyzing a corpus of textual documents (or documents with textual portions) and identifying sequences of words which commonly occur in sequence over the corpus. The n-gram data store 205 may optionally store, for all or any of the n-grams, a measure of frequency of occurrence of the n-gram within the corpus, such as an occurrence count, or a value derived from the occurrence count, such as the ratio of the occurrence count to the number of documents in the corpus.

In one embodiment, the n-gram data store 205 may include multiple distinct sub-stores, each corresponding to a particular document corpus. For example, one sub-store could correspond to a set of documents on scientific topics; another sub-store could correspond to a set of digital books of fiction; and another sub-store could correspond to webpages from the .edu domain. In such an embodiment, the text expansion module 206 could identify a context of text currently being displayed by the application 202 and further identify a specific sub-store of particular relevance to that context, referring to the n-grams of the specific sub-store when expanding text selections. This permits expanding selections in a manner most appropriate to the context. Identifying the context of the text currently being displayed is accomplished in different ways in different embodiments, such as inferring a topic from the text itself (e.g., mapping the words of the text to a topic, such as “literature” or “technology”).

The text expansion module 206 identifies, given a user interaction with a portion of a user interface displaying text, a semantically-meaningful related portion of the text. In one embodiment, the text expansion module 206 identifies a particular word indicated by the user interaction with a text region—such as a user pressing and holding on a particular word via a touchscreen, or a user clicking on, or dragging across, a word using a mouse or other pointing device—and forms a set of candidate n-grams that are within the text region and that include the identified word. The text expansion module 206 additionally identifies which (if any) of the candidate n-grams are known n-grams (i.e., are within the n-gram data 205). If at least one of the candidate n-grams is a known n-gram, the text expansion module 206 chooses one of the known n-grams from the candidate n-grams as its text expansion.

The text action module 207 takes one or more actions in response to the known n-gram selected by the text expansion module 206 from the candidate n-grams (if any). For example, in one embodiment the text action module 207 selects the text of the text region that corresponds to the n-gram chosen by the text expansion module 206, or expands an existing selection to include that text. The text action module 207 may allow the user to “undo” the selection of a chosen text expansion in response to receiving a specified user input, such as by performing a touchscreen gesture such as a swipe, by pressing a particular key, by activating a given user interface element (e.g., pressing a “Undo expansion” region of the user interface), or the like. (Such an “undo” might cause the text selection of FIG. 1C to revert to that of FIG. 1B, for example.)

In one embodiment, the text action module 207 performs a query using the selected n-gram, or displays a definition of the selected n-gram, as illustrated in text region 110 of FIG. 1C. In one embodiment, the text action module 207 displays a set of possible actions, e.g. in a popup context menu, such as querying various search engines for the selected n-gram, displaying a definition of the selected n-gram, searching local storage for documents associated with the selected n-gram, or the like.

In one embodiment, the user of the application 202 may specify his or her preference regarding text expansion behavior, such as enabling or disabling the automatic actions of the text expansion module 206 and the text action module 207.

It is appreciated that, although the application 202 and text selection module 204 and its constituent components are depicted in FIG. 2 as being part of the client device 200, some or all could also be located on a separate system, such as a remote application server. For example, the n-gram data 205 could be stored on a remote system before being provided for the use of a text selection module 204 located on the client device 200. As another example, the application 202 and the text selection module 204 and all its components could be run on an application server accessed by the client device 200 over a network, with the client receiving and displaying visual output of the application, e.g., in a web browser. For instance, the server could generate and provide to clients an HTML and JavaScript-based user interface that, when rendered by the application 202 of the client device 200, displays the text. Such a server-provided user interface could also identify user interactions with words of the text, either performing the text expansion and text actions locally on the client device 200, or sending indications of the interactions to the remove server, which could in turn send additional data to the application 202 that would cause the application 202 to accomplish the text expansion and text actions.

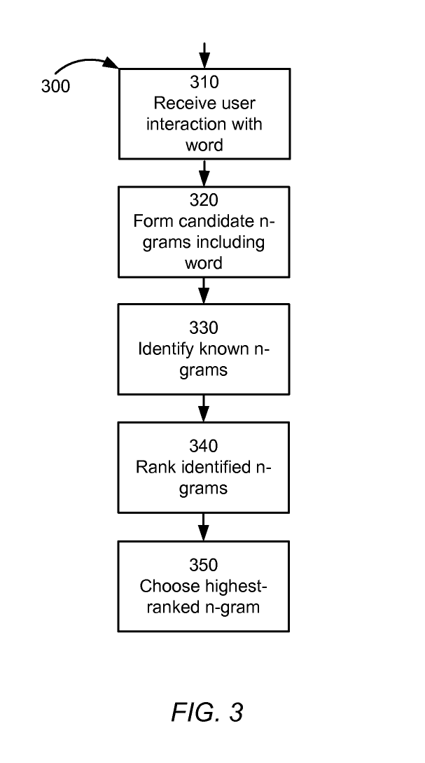

FIG. 3 is a flowchart illustrating actions of the text expansion module 206, according to one embodiment. The application 202 receives 310 a user interaction with an instance of a word displayed within a text region of the user interface. For example, referring back to FIGS. 1A and 1B, the user has selected the word “attention” within the text region 105, the selection (or the resulting press or press-and-hold that led to the selection) being the corresponding user interaction with the word.

The text expansion module 206 forms 320 candidate n-grams including the word instance (“attention”), including n-grams of up to n words. For example, if n=4, then the n-grams include the strings with up to four ordered words that include the interacted-with instance of the word “attention”, namely the 4-grams “severe case of attention”, “case of attention deficit”, “of attention deficit disorder”, and “attention deficit disorder. Boys”; the 3-grams “case of attention”, “of attention deficit”, and “attention deficit disorder; and the 2-grams “of attention” and “attention deficit”. (Note that for a given n, there will be E[1, n](i)−1=((n)(n+1)/2)−1 candidate n-grams, if the 1-gram for the word itself is not included.)

The text expansion module 206 identifies 330 the known n-grams within the set of candidate n-grams—that is, the n-grams that are in both the set of candidate n-grams and the n-gram data store 205. (In an embodiment in which there are multiple sub-stores within the n-gram data store 205, the text expansion module 206 first identifies the particular sub-store most relevant to the user's current context, and then uses the n-grams in that sub-store as the set of known n-grams.)

Referring again to the above example, if the n-gram “attention deficit disorder” were the only candidate n-gram that is also a known n-gram, then the text expansion module 206 would choose 350 that n-gram as its output. If, however, there were multiple candidate n-grams that were also known n-grams, then in one embodiment the text expansion module 206 would rank 340 those n-grams, e.g., based on measures of frequency associated with the n-grams in the n-gram data store 205, and choose the highest-ranking of those n-grams as its output.

With an n-gram selected by the text expansion module 206, the text action module 207 can take one or more actions, such as visually selecting the portion of the text corresponding to the selected n-gram, such as the phrase “attention deficit disorder” that is highlighted in FIG. 1C.

A similar process would occur for the scenario illustrated in FIGS. 1D-1E. For example, the application would receive 310 a user interaction with the word instance “Boys” as a result of the user manually expanding the right-hand end of the previous selection to include the word “Boys”. As a result, (assuming n=4) the text expansion module 206 would form 320 the candidate n-grams “attention deficit disorder. Boys”, “deficit disorder. Boys will”, “disorder. Boys will be”, “Boys will be boys”, “deficit disorder. Boys”, “disorder. Boys will”, “Boys will be”, “disorder. Boys”, and “Boys will”. Of these candidate n-grams, assuming that only the 4-gram “Boys will be boys” is a known n-gram, the text expansion module 206 would choose 350 that n-gram, and the text action module 207 would (for example) visually select the corresponding portion of the text, obtain an explanation of the phrase, and display the explanation in the region 115, as illustrated in FIG. 1E.

FIG. 4 is a high-level block diagram illustrating physical components of a computer system 400, which can serve as the client device 200 of FIG. 2, according to one embodiment. Illustrated are at least one processor 402 coupled to a chipset 404. Also coupled to the chipset 404 are a memory 406, a storage device 408, a keyboard 410, a graphics adapter 412, a pointing device 414, and a network adapter 416. A display 418 is coupled to the graphics adapter 412. In one embodiment, the functionality of the chipset 404 is provided by a memory controller hub 420 and an I/O controller hub 422. In another embodiment, the memory 406 is coupled directly to the processor 402 instead of the chipset 404.

The storage device 408 is any non-transitory computer-readable storage medium, such as a hard drive, compact disk read-only memory (CD-ROM), DVD, or a solid-state memory device. The memory 406 holds instructions and data used by the processor 402. The pointing device 414 may be a mouse, track ball, or other type of pointing device, and is used in combination with the keyboard 410 to input data into the computer 400. The graphics adapter 412 displays images and other information on the display 418. The network adapter 416 couples the computer system 400 to a local or wide area network.

As is known in the art, a computer system 400 can have different and/or other components than those shown in FIG. 4. In addition, the computer 400 can lack certain illustrated components. For example, in one embodiment, if a computer system 400 is a smartphone it may lack a keyboard 410, pointing device 414, and/or graphics adapter 412, and have a different form of display 418. Moreover, the storage device 408 can be local and/or remote from the computer 400 (such as embodied within a storage area network (SAN)).

As is known in the art, the computer system 400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 408, loaded into the memory 406, and executed by the processor 402.

Embodiments of the entities described herein can include other and/or different modules than the ones described here. In addition, the functionality attributed to the modules can be performed by other or different modules in other embodiments. Moreover, the description occasionally omits the term “module” for purposes of clarity and convenience.

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method comprising:
receiving a user interaction with a first word in an ordered set of words displayed in a user interface;
forming a set of candidate n-grams, each candidate n-gram being a sequence of up to n adjacent words within the ordered set of words that includes the first word;
identifying known n-grams within the set of candidate n-grams; and
taking an action on one of the identified known n-grams.

2. The computer-implemented method of claim 1, further comprising accessing a set of known n-grams, wherein identifying known n-grams within the set of candidate n-grams comprises determining which of the candidate n-grams are within the set of known n-grams.

3. The computer-implemented method of claim 2, further comprising:
determining measures of frequency of occurrence of n-grams of the set of known n-grams;
ranking the identified known n-grams using the measures of frequency of occurrence; and
taking the action on at least a highest-ranked one of the identified known n-grams.

4. The computer-implemented method of claim 2, further comprising:
identifying a topic associated with a context of the ordered set of words; and
identifying the known n-grams based on the identified topic.

5. The computer-implemented method of claim 1, wherein the action taken comprises visually selecting the one of the identified known n-grams.

6. The computer-implemented method of claim 1, further comprising, responsive to receiving a user input, removing the visual selection of at least part of the one of the identified known n-grams.

7. The computer-implemented method of claim 1, wherein the action taken comprises providing a definition of at least the one of the identified known n-grams.

8. A non-transitory computer-readable storage medium comprising instructions executable by a processor, the instructions comprising:
instructions for receiving a user interaction with a first word in an ordered set of words displayed in a user interface;
instructions for forming a set of candidate n-grams, each candidate n-gram being a sequence of up to n adjacent words within the ordered set of words that includes the first word;
instructions for identifying known n-grams within the set of candidate n-grams; and
instructions for taking an action on one of the identified known n-grams.

9. The non-transitory computer-readable storage medium of claim 8, the instructions further comprising accessing a set of known n-grams, wherein identifying known n-grams within the set of candidate n-grams comprises determining which of the candidate n-grams are within the set of known n-grams.

10. The non-transitory computer-readable storage medium of claim 9, the instructions further comprising:
instructions for determining measures of frequency of occurrence of n-grams of the set of known n-grams;
instructions for ranking the identified known n-grams using the measures of frequency of occurrence; and
instructions for taking the action on a highest-ranked one of the identified known n-grams.

11. The non-transitory computer-readable storage medium of claim 9, the instructions further comprising:
instructions for identifying a topic associated with a context of the ordered set of words; and
instructions for identifying at least the known n-grams based on the identified topic.

12. The non-transitory computer-readable storage medium of claim 8, wherein the action taken comprises visually selecting the one of the identified known n-grams.

13. The non-transitory computer-readable storage medium of claim 8, further comprising instructions for, responsive to receiving a user input, removing the visual selection of at least part of the one of the identified known n-grams.

14. The non-transitory computer-readable storage medium of claim 8, wherein the action taken comprises providing a definition of at least the one of the identified known n-grams.

15. A computer system comprising:
a computer processor; and
a non-transitory computer-readable storage medium comprising:
instructions for receiving a user interaction with a first word in an ordered set of words displayed in a user interface;
instructions for forming a set of candidate n-grams, each candidate n-gram being a sequence of up to n adjacent words within the ordered set of words that includes the first word;
instructions for identifying known n-grams within the set of candidate n-grams; and
instructions for taking an action on one of the identified known n-grams.

16. The computer system of claim 15, further comprising accessing a set of known n-grams, wherein identifying known n-grams within the set of candidate n-grams comprises determining which of the candidate n-grams are within the set of known n-grams.

17. The computer system of claim 16, further comprising:
instructions for determining measures of frequency of occurrence of n-grams of the set of known n-grams;
instructions for ranking the identified known n-grams using the measures of frequency of occurrence; and
instructions for taking the action on a highest-ranked one of the identified known n-grams.

18. The computer system of claim 16, further comprising:
instructions for identifying a topic associated with a context of the ordered set of words; and
instructions for identifying the known n-grams based on the identified topic.

19. The computer system of claim 15, wherein the action taken comprises visually selecting the one of the identified known n-grams.

20. The computer system of claim 15, further comprising instructions for, responsive to receiving a user input, removing the visual selection of at least part of the one of the identified known n-grams.
